(19) United States
(12) Patent Application Publication
(10) Pub. No.: US 2006/0236574 A1
(43) Pub. Date: Oct. 26, 2006

(54) Magnetic display

(76) Inventor: Amin Guntur, Flushing, NY (US)

Correspondence Address: Mr. Walter J. Tencza Jr.;Suite 3, 10 Station Place, Metuchen, NJ, 08840, US

(21) Appl. No.: 11/093,513

(22) Filed: Mar. 30, 2005

(51) Int. Cl. G09F 7/04

(52) U.S. Cl. 40/600

(57) ABSTRACT

An apparatus for displaying items for sale is provided. The apparatus may include first, second, third, and fourth walls which make up a box structure. First, second, third, and fourth magnets may be permanently fixed to the first, second, third, and fourth walls, respectively. Each magnet exerts a magnetic force. First, second, third, and fourth items for sale, can be held by the first, second, third, and fourth magnets, respectively, to display the items in an upright position.

### FIELD OF THE INVENTION

This invention relates to improved methods and apparatus concerning the display of goods for sale at a retail store.

### BACKGROUND OF THE INVENTION

Typically, in the prior art, items displayed for sale at a retail store are placed on a shelf or on a base surface.

### SUMMARY OF THE INVENTION

The present invention in one or more embodiments, provides an apparatus for displaying items for sale. The apparatus may include first, second, third, and fourth walls which make up a box structure. First, second, third, and fourth magnets may be permanently fixed to the first, second, third, and fourth walls, respectively. Each magnet exerts a magnetic force. First, second, third, and fourth items for sale, can be held by the first, second, third, and fourth magnets, respectively, to display the items in an upright position.

The magnets may be fixed to the walls by a nut and a bolt. The magnets may be spaced apart from the walls by spacers. A transparent covering may be provided to cover the box structure, the first, second, third, and fourth magnets and the first, second, third, and fourth items. The box structure and the transparent covering may be located on the rotation device. The rotation device can rotate the box structure and the transparent covering in order to display the items from different viewpoints. The rotation device may include a motor for rotating the box structure and the transparent covering.

A method is also provided comprising permanently fixing a first magnet to a first wall, wherein the first magnet exerts a first magnetic force, placing a first item in contact with the first magnet to cause the first item to be held by the first magnetic force of the first magnet; and displaying the first item for sale while the first item is held by the first magnetic force of the first magnet.

### BRIEF DESCRIPTION OF THE DRAWINGS

FIG. 1 shows a perspective view of an apparatus in accordance with an embodiment of the present invention;

FIG. 2 shows a perspective view of the apparatus of FIG. 1 inside a transparent covering;

FIG. 3 shows a top view of the apparatus of FIG. 1 inside the transparent covering of FIG. 2 and on top of a turntable or rotation device;

FIG. 4 shows a side view of an object held by a magnet;

FIG. 5 shows a perspective view of an alternative transparent covering;

FIG. 6 shows a side view of another object held by a magnet;

FIG. 7 shows a side view of an alternative technique of permanently fixing a magnet to a wall; and

FIG. 8 shows a side view of another alternative technique of permanently fixing a magnet to a wall.

### DETAILED DESCRIPTION OF THE DRAWINGS

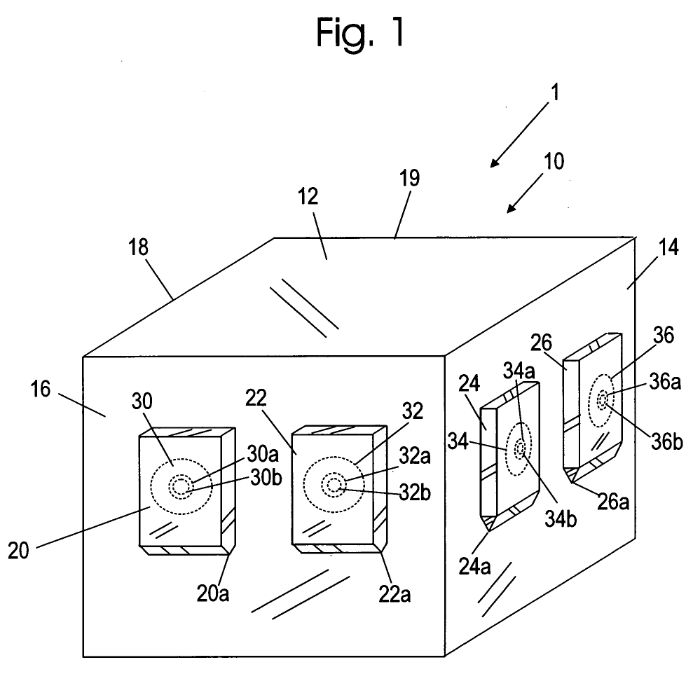

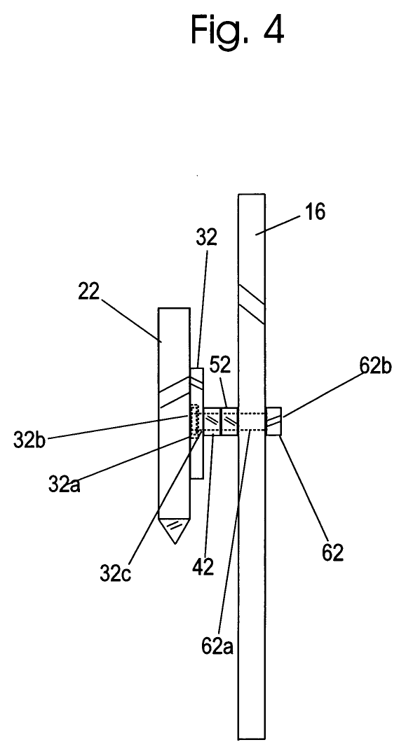

FIG. 1 shows a perspective view of an apparatus 1 in accordance with an embodiment of the present invention. FIG. 4 shows a side view of an object or item 22 held by a magnet 32.

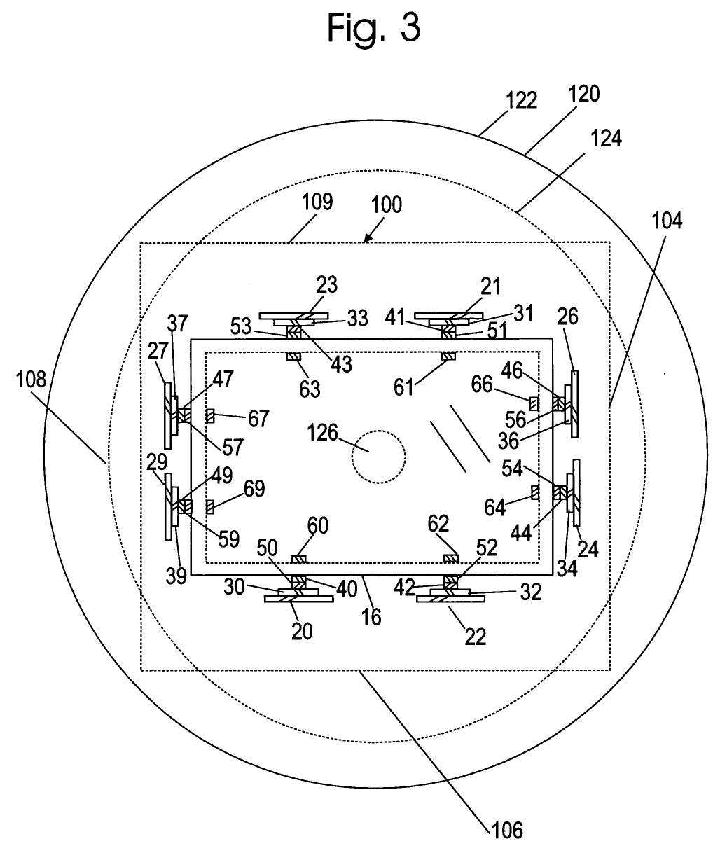

The apparatus 1 includes a box 10 having a top surface 12, and sides or walls 14, 16, 18, and 19. The apparatus 1 also includes items 20, 22, 24, and 26 shown in FIG. 1 and items 21, 23, 27, and 29 shown in FIG. 3. The items 20, 21, 22, 23, 24, 26, 27, and 29 are held to the box 10 by magnets 30, 31, 32, 33, 34, 36, 37, and 39, respectively, as shown by FIG. 3. Each of the items 20, 21, 22, 23, 24, 26, 27, and 29 may have a beveled edge. For example items 20, 22, 24, and 26 may have a beveled edge 20a, 22a, 24a, and 26a, respectively, as shown in FIG. 1. The beveled edges make it difficult to stand the items upright on a shelf for display. The items may alternatively be shaped or sized or have a bottom surface which makes it difficult for them to stand upright. The present invention in one or more embodiments allows items to be placed in an upright position whether they have perfectly flat surfaces or not. In the embodiment of FIG. 1, the top surface 12, walls 14, 16, 18, and 19 may be opaque. The locations of magnets 30, 31, 32, 33, 34, 36, 37, and 39 are shown in dashed lines but the magnets typically would not be visible from the perspective of FIG. 1 but rather located behind the appropriate item.

The magnets 30, 31, 32, 33, 34, 36, 37, and 39 are fixed to the box 10 by bolts 60, 61, 62, 63, 64, 66, 67, and 69, respectively and a nut for each bolt. Referring to FIG. 4, a nut 32b is screwed onto the portion 62a of the bolt 62 to fix the magnet 32 to the wall 16 of the box 10. The portion 62a passes through an opening in the wall 16, through the nuts or spacers 52 and 42 and through the opening 32a in the magnet 32. The nut 32b may be inserted into an indentation or recess 32a in the magnet 32. The magnet 32 may also have an opening 32c, which goes through the magnet 32. The nut 32b is of a size, such that it can not pass through the opening 32c. Nuts 30b, 34b, and 36b, whose locations are shown by dashed lines in FIG. 1, would also be provided and may be identical to nut 32b. The magnet 32 may be separated from the wall 16 by spacers, such as nuts 42 and 52 shown in FIG. 4. The magnets 30, 31, 33, 34, 36, and 37 may be fixed to the box 10 in a manner similar to magnet 32. Referring to FIG. 3, the magnets 30 and 32 are fixed to the wall 16 by bolts 60 and 62, and corresponding nuts, respectively. The magnets 24 and 26 are fixed to the wall 14 by bolts 64 and 66 and corresponding nuts, not shown, respectively. The magnets 21 and 23 are fixed to the wall 19 by bolts 61 and 63 and corresponding nuts, not shown, respectively. The magnets 27 and 29 are fixed to the wall 18 by bolts 67 and 69 and corresponding nuts, not shown, respectively.

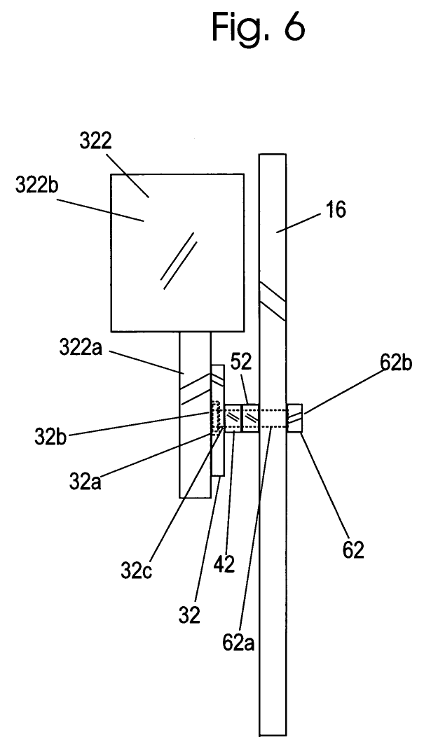

The bolt 60 is inserted through spacers or nuts 40 and 50. The bolt 61 is inserted through spacers or nuts 41 and 51. The bolt 62 is inserted through spacers or nuts 42 and 52. The bolt 63 is inserted through spacers or nuts 43 and 53. The bolt 64 is inserted through spacers or nuts 44 and 54. The bolt 66 is inserted through spacers or nuts 46 and 56. The bolt 67 is inserted through spacers or nuts 47 and 57. The bolt 69 is inserted through spacers or nuts 49 and 59. The spacers or nuts 40, 41, 42, 43, 44, 46, 47, and 49 and 50, 51, 52, 53, 54, 56, and 57 purpose, help to give the appearance that the items 20, 21, 22, 23, 24, 26, 27, and 29 are suspended in midair, when an item is viewed from the front of the item. In addition, as will be described with reference to FIG. 6, the spacers aid in displaying a product upright when the product does not have a flat metal surface for the magnet to attach to or the product is comprised of a flat metallic surface portion and an uneven non-metallic surface portion. The spacers 40, 41, 42, 43, 44, 46, and 47 may be made of any type of material, and the size, diameter, shape, and number of spacers provided may vary.

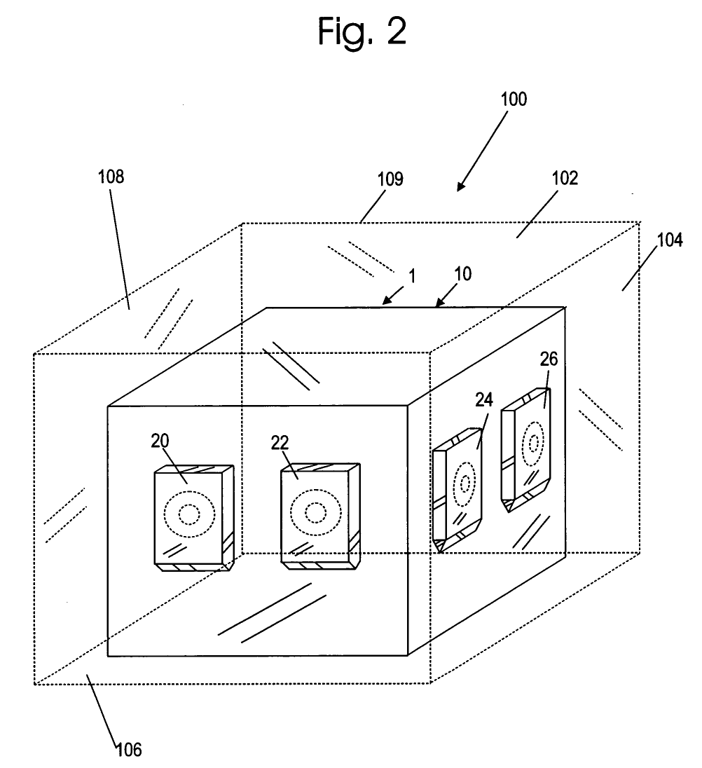

FIG. 2 shows a perspective view of the apparatus 1 of FIG. 1 inside a transparent covering 100. The transparent covering 100 includes top surface 102 and sides or walls 104, 106, 108, and 109. The transparent covering 100 may be made of Plexiglas. The transparent covering 100 allows the items, such as items 20, 22, 24, and 26 shown in FIG. 2, to be viewed while preventing a person or customer from touching, damaging, or removing the items.

FIG. 3 shows a top view of the apparatus 1 of FIG. 1 inside the transparent covering 100 of FIG. 2 and on top of a turntable or rotation device 120. Referring to FIG. 3, the turntable or rotation device 120 may include a top surface 122 and axis, axle or pivot pin 126 (location shown in dashed lines in FIG. 3), and a base 124 (shown in dashed lines in FIG. 3). The base 124 would lies beneath the top surface 122. The axis or pivot pin 126 connects the top surface 122 to the base 124 in a manner which allows the top surface 122 to rotate with respect to the base 124 about the axis or pivot pin 126. The apparatus 1 and transparent covering 100 sit on the top surface 122 and rotate with the top surface 122. The top surface 122, apparatus 1, and transparent covering 100 rotate to allow a customer to get a better look or a different look at one or more of the items 20, 21, 22, 23, 24, 26, 27, and 29. The top surface 122 of the rotation device 120 may be rotated manually or by a motor. The base 124 may include a motor which can rotated the top surface 122. The motor may rotate the top surface 122 at a fixed constant rate so that different views of the items 20, 21, 22, 23, 24, 26, 27, and 29 are being shown on a regular basis.

The magnets 30, 31, 32, 33, 34, 36, 37, and 39 may each be very strong magnets commonly named “rare earth magnets”. Alternatively, the magnets 30, 31, 32, 33, 34, 36, 37, and 39 may each be any type of magnet. Although the magnets 30, 31, 32, 33, 34, 36, 37, and 39 are shown bolted to their respective walls in FIG. 3, each of the magnets can be glued, screwed, welded, or permanently attached in any other known manner. Although, only eight magnets are shown in FIG. 3, any number of magnets can be provided. In addition the shape, size, and thickness of the magnets may be varied.

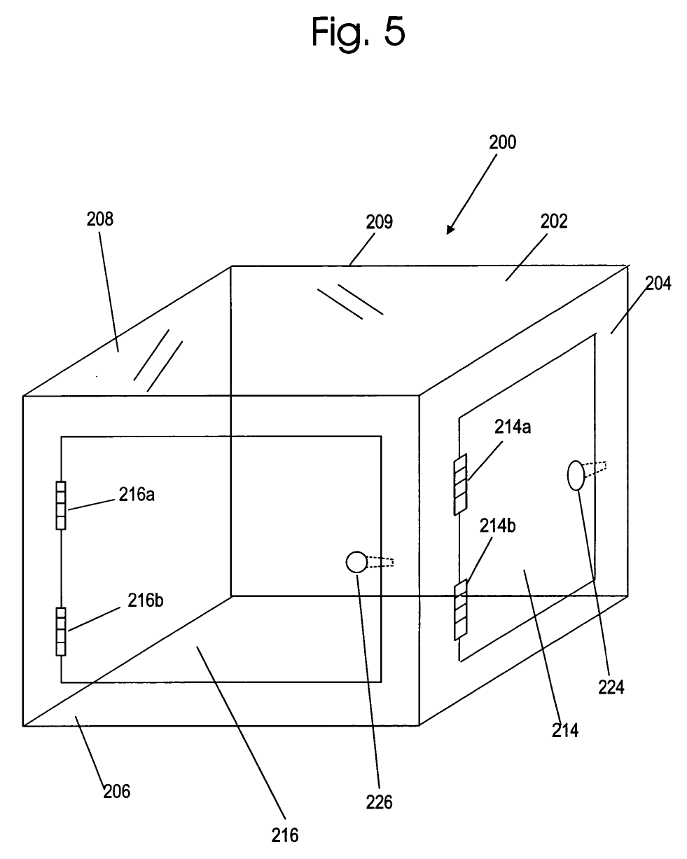

The box structure 10 (including walls 14, 16, 18, and 19 and top surface 12) can be made of plastic, Plexiglas, wood, aluminum, or any other suitable material. The transparent covering 100 can be made of plastic, Plexiglas, or glass. The transparent covering 100 can have a door or doors such as shown in FIG. 5.

Each of the items 20, 21, 22, 23, 24, 26, 27, and 29 is typically partially or completely metal so that a magnet can attract them. The items can be any type of item for display such as cigarette lighters, jewelry, and calculators, as examples. The use of the magnets 30, 31, 32, 33, 34, 36, 37, and 39 allows the products to be easily removed and for different products to be easily inserted and attached to the magnets.

The rotation device 120 can be a commonly used display rotating device, which can be attached at the bottom of the box structure 10. The box structure 10 can be square, rectangular, octagon, round, or any other shape.

The apparatus 1, with or without covering 100, can be use in a retail store, convenience store, department store, truck stop, trade show and showroom.

FIG. 5 shows a perspective view of an alternative transparent covering 200. The covering 200 has top surface 202, and sides 204, 206, 208, and 209. The covering 200 includes transparent doors 214 and 216. The door 214 is attached to the side 204 by hinges 214a and 214b. The door 214 can be described as being a part of the side 204. The door 214 can be locked by lock 224. The door 216 is attached to the side 206 by hinges 216a and 216b. The door 216 can be described as being a part of the side 206. The door 216 can be locked by lock 226. The covering 200 can be placed over the box structure 10 instead of the covering 100. The hinges 214a, 214b, 216a, and 216b can be made of any material such as wood, metal, aluminum, or Plexiglas. Although only two doors are shown, a door can be located on each of sides 204, 206, 208, and 209.

FIG. 6 shows a side view of an object 322 held by magnet 32. The object 322 has a portion 322b and a portion 322a. The portion 322a is made of metal and physically contacts the magnet 32. The portion 322b may not be made of metal. The portion 322b is larger than the portion 322a. The spacers 42 and 52 allow the product 322 to be viewed in an upright position.

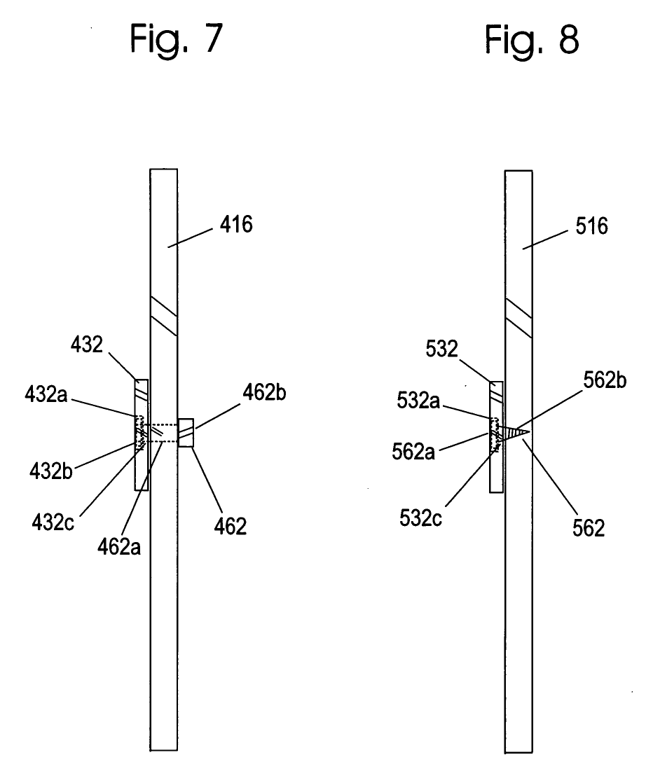

FIG. 7 shows a side view of an alternative technique of permanently fixing a magnet to a wall. FIG. 7 shows a magnet 432 fixed to a wall 416 by a bolt 462. Spacers are not used in the FIG. 7 embodiment. A nut 432b inserted into a recess 432a, is screwed onto a portion 462a of the bolt 462. The bolt 462 includes a head portion 462b. The magnet 432 includes an opening 432c, through which the portion 462a of the bolt 462 passes. The wall 416 may be identical to the wall 16 and may be part of a box structure identical to box structure 10 in FIG. 1.

FIG. 8 shows a side view of another alternative technique of permanently fixing a magnet to a wall. FIG. 8 shows a magnet 532 fixed to a wall 516 by a screw 562. The screw includes a threaded portion 562b and a head portion 562a. The threaded portion 562b is inserted through opening 532c in magnet 532 and into wall 516. After insertion of the threaded portion 562b, the head portion 562a lies in a recess 532a and cannot pass through the opening 532c of the magnet 532.

The spacers such as spacers or nuts 42 and 52 of FIG. 6 can be made of any suitable material such as metal, wood, plastic, or Plexiglas.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus for displaying items for sale comprising:
a first wall; and
a first magnet permanently fixed to the first wall;
wherein the first magnet exerts a first magnetic force; and
wherein the first magnet is permanently fixed to the first wall in a manner, which allows a first item to directly contact the first magnet and to thereby be held by the first magnetic force to the first wall.

2. The apparatus of claim 1 wherein
the first magnet is permanently fixed to the first wall by a bolt.

3. The apparatus of claim 1 wherein
the first magnet is permanently fixed in a manner so that the first magnet is spaced apart from the first wall and the first magnet does not directly contact the first wall.

4. The apparatus of claim 1 further comprising
a second wall;
a second magnet permanently fixed to the second wall;
wherein the second magnet exerts a second magnetic force; and
wherein the second magnet is permanently fixed to the second wall in a manner, which allows a second item to directly contact the second magnet and to thereby be held by the second magnetic force to the second wall.

5. The apparatus of claim 4 wherein
the second wall is connected to the first wall.

6. The apparatus of claim 5 wherein
the second wall lies at an angle with respect to the first wall.

7. The apparatus of claim 6 wherein
the second wall is substantially perpendicular to the first wall.

8. The apparatus of claim 4 further comprising
a third wall;
a third magnet permanently fixed to the third wall;
wherein the third magnet exerts a third magnetic force;
wherein the third magnet is permanently fixed to the third wall in a manner which allows a third item to directly contact the third magnet and to thereby be held by the third magnetic force to the third wall; and
a further comprising a fourth wall;
a fourth magnet permanently fixed to the fourth wall;
wherein the fourth magnet exerts a fourth magnetic force; and
wherein the fourth magnet is permanently fixed to the fourth wall in a manner, which allows a fourth item to directly contact the fourth magnet and to thereby be held by the fourth magnetic force to the fourth wall;
and wherein the first, second, third, and fourth walls form four sides of a box structure having an outer surface, and the first, second, third, and fourth magnets fixed to the outer surface of the box structure.

9. The apparatus of claim 8 further comprising
a transparent covering adapted to cover the box structure, the first, second, third, and fourth magnets and the first, second, third, and fourth items.

10. The apparatus of claim 9 further comprising
a rotation device;
wherein the box structure and the transparent covering are located on the rotation device, such that the rotation device can rotate the box structure and the transparent covering.

11. The apparatus of claim 10 wherein
the rotation device includes a motor for rotating the box structure and the transparent covering.

12. A method comprising
permanently fixing a first magnet to a first wall, wherein the first magnet exerts a first magnetic force;
placing a first item in contact with the first magnet to cause the first item to be held by the first magnetic force of the first magnet; and
displaying the first item for sale while the first item is held by the first magnetic force of the first magnet.

13. The method of claim 12 wherein
the first magnet is permanently fixed to the first wall by a bolt.

14. The method of claim 12 wherein
the first magnet is permanently fixed in a manner so that the first magnet is spaced apart from the first wall and the first magnet does not directly contact the first wall.

15. The method of claim 12 further comprising
permanently fixing a second magnet to a second wall, wherein the second magnet exerts a second magnetic force;
placing a second item in contact with the second magnet to cause the second item to be held by the second magnetic force of the second magnet; and
displaying the second item for sale while the second item is held by the second magnetic force of the second magnet.

16. The method of claim 15 further comprising
connecting the second wall to the first wall.

17. The method of claim 16 wherein
the second wall is connected to the first wall so that the second wall lies at an angle with respect to the first wall.

18. The method of claim 17 wherein
the second wall is connected to the first wall so that the second wall is substantially perpendicular to the first wall.

19. The method of claim 15 further comprising
permanently fixing a third magnet to a third wall, wherein the third magnet exerts a third magnetic force;
placing a third item in contact with the third magnet to cause the third item to be held by the third magnetic force of the third magnet;
displaying the third item for sale while the third item is held by the third magnetic force of the third magnet;
permanently fixing a fourth magnet to a fourth wall, wherein the fourth magnet exerts a fourth magnetic force;
placing a fourth item in contact with the fourth magnet to cause the fourth item to be held by the fourth magnetic force of the fourth magnet; and
displaying the fourth item for sale while the fourth item is held by the fourth magnetic force of the fourth magnet;
and wherein the first, second, third, and fourth walls form four sides of a box structure having an outer surface, and the first, second, third, and fourth magnets fixed to the outer surface of the box structure.

20. The method of claim 19 further comprising
placing a transparent covering over the box structure so that the transparent covering covers the box structure and the first, second, third, and fourth magnets and the first, second, third, and fourth items.

21. The method of claim 20 further comprising
placing the box structure and the transparent covering on a rotation device; and
wherein the rotation device can rotate the box structure and the transparent covering.

22. The method of claim 21 wherein
the rotation device includes a motor for rotating the box structure and the transparent covering.
